(19) United States
(12) Patent Application Publication
(10) Pub. No.: US 2020/0174856 A1
(43) Pub. Date: Jun. 4, 2020

(54) SCALABLE EVENT DELIVERY SYSTEM AND METHOD SUPPORTING FLEXIBILITY

(71) Applicant: ELECTRONICS AND TELECOMMUNICATIONS RESEARCH INSTITUTE, DAEJEON (KR)

(72) Inventors: Kang Il CHOI, Daejeon (KR); Sun Me KIM, Daejeon (KR); Hee Young JUNG, Daejeon (KR)

(21) Appl. No.: 16/561,431

(22) Filed: Sep. 5, 2019

(30) Foreign Application Priority Data
Nov. 29, 2018 (KR) 10-2018-0150525
May 22, 2019 (KR) 10-2019-0060028

(51) Int. Cl. G06F 9/54

(52) U.S. Cl. CPC G06F 9/542

(57) ABSTRACT

The present invention relates to a system and method of delivering network data and, more particularly, to a scalable event delivery system and method supporting flexibility. The scalable event delivery system supporting flexibility includes, among a common core module, a convenience core module, a scale core module, and an extension function module, each being a function module considering a property of each of event processing functions, an event delivery system module configured by combining two or more modules including at least the common core module on the basis of a specific event processing environment; and a processor performing the specific event processing by using the event delivery system module. The scalable event delivery system supporting flexibility further includes a network adaptation module and a protocol adaptation module.

### CROSS REFERENCE TO RELATED APPLICATIONS

The present application claims priority to Korean Patent Application Nos. 10-2018-0150525, filed Nov. 29, 2018, and 10-2019-0060028, filed May 22, 2019, the entire contents of which are incorporated herein for all purposes by this reference.

### BACKGROUND OF THE INVENTION

### 1. Field of the Invention

The present invention relates to a system and method of delivering network data and, more particularly, to a scalable event delivery system and method supporting flexibility.

### 2. Description of Related Art

Recently, a variety of new services such as IoT service, telemedicine service, high quality video service, AR/VR, etc. through a hyper-connected network are emerging. The services have different service requirements from each other (e.g., bandwidth guarantee, low latency guarantee, etc.).

Particularly, with regard to event-driven services (e.g., real-time IoT services, etc.), a configuration of a system capable of delivering large-scale events occurring in real time in a scalable manner to where the corresponding events should be processed or delivered is required, as well as an event delivery system capable of providing flexible processing of large-capacity events of new types of services is required.

Specifically, in the case of the event delivery system in the related art, each event delivery system is a modular configuration for effectively processing only the event which is a processing target of each event delivery system, whereby it is possible to effectively process only the corresponding event in a scalable manner, but it is impossible to meet requirements of flexibly processing a new type of event in a new way.

For example, a system implemented with a Message Queuing Telemetry Transport (MQTT) protocol or an Advanced Message Queuing Protocol (AMQP) protocol can deliver and process large-capacity IoT traffic in a scalable manner, but cannot provide flexible processing capabilities for the corresponding IoT traffic. In addition, a Kafka system can perform a storage processing function for message delivery traffic, but it does not provide flexible processing for large-capacity traffic such as IoT.

Also, for example, the event delivery system in the related art is provided so that two different systems (e.g., “MQTT+Kafka” or “AMQP+Kafka”) designed and modularized to be optimized for each processing traffic are connected using a relay system and processed, in order to process and deliver a new IoT traffic in a scalable and flexible manner. Therefore, the event delivery system of the combined structure in the related art not only includes a large number of unnecessary functions in processing and delivering new IoT traffic, but also needs to be combined with a new system for processing the corresponding functions again when processing of other new type of traffic is required.

As a result, the event delivery system in the related art has a problem in that it does not simultaneously provide the scalability and flexibility of the event delivery system. Accordingly, there is a need for an event delivery system and method that simultaneously provides scalability and flexibility in an event delivery system that must process a new type of event corresponding to a current hyper-connected network.

### SUMMARY OF THE INVENTION

Accordingly, in order to solve the problems of the prior art described above, an objective of the present invention is to provide an event delivery system and method simultaneously providing scalability and flexibility.

In addition, in order to solve the problems of the prior art described above, an object of the present invention is to provide a scalable event delivery system and method supporting flexibility, by which processing of various types of event data is impossible.

Another object of the present invention is to provide a scalable event delivery system and an event delivery method that support flexibility in processing a new type of event data in a hyper-connected network, in order to solve the aforementioned problems of the related art.

In addition, in order to solve the problems of the prior art described above, an object of the present invention is to provide a scalable event delivery system and an event delivery method supporting flexibility, in which when constructing and providing an event delivery system for optimally delivering and processing a new type of event data in a hyper-connected network, only functions necessary for processing the corresponding new type of event data are used by flexibly combining a common core module, a convenience core module, a scale core module, an extension function module, a protocol adaptation module, and a network adaptation module.

Other objects and advantages of the present invention can be understood by the following description, and will be more clearly understood by the embodiments of the present invention. It will also be appreciated that the objects and advantages of the present invention may be realized by the means and combinations thereof indicated in the claims.

In order to achieve the above object, a scalable event delivery system supporting flexibility according to the present invention includes: among a common core module, a convenience core module, a scale core module, and an extension function module, each being a function module considering a property of each of event processing functions, an event delivery system module configured by combining two or more modules including at least the common core module on the basis of a specific event processing environment; and a processor performing the specific event processing by using the event delivery system module.

In addition, the common core module may include all common essential functions necessary for the specific event processing environment among the event processing functions.

In addition, the common core module includes at least one of a subscription management function, a topic management function, a forwarding function, a routing function, a best-effort delivery function, and a subscriber health management function, and a police management function.

In addition, the convenience core module may include, among the event processing functions, auxiliary functions for increasing convenience related to the specific event processing environment.

In addition, the convenience core module may include at least one of a queue management function, a core consumer health management function, and an authorization function.

In addition, the scale core module may include additional functions related to the specific event processing environment, among the event processing functions.

In addition, the scale core module may include at least one of a log and record management function, a scale core policy management function, a scale core consumer health management function, and a consumer group management function, a partition management function, a replication management function, and an authentication and authorization function.

In addition, the extension function module may include extension functions related to the specific event processing environment, among the event processing functions.

In addition, the extension function module may include at least one of a connector function, a QOS level 0 function, a QOS level 1 function, a QOS level 2 function, and an order control function, a data pre-processing transformer function, and a stream processing operation function.

In addition, when the specific event processing environment is an event delivery system requiring delivery scalability, the event delivery system module may be configured by combining the common core module, the convenience core module, and the extension function modules.

In addition, when the specific event processing environment is associated with MQTT event processing, the event delivery system module may be configured to include the common core module, the convenience core module, and the extension function module, in which functions of the extension function module include a QOS level 0 function and a QoS Level 1 function.

In addition, when the specific event processing environment is associated with AMQP event processing, the event delivery system module may be configured to include the common core module, the convenience core module, and the extension function module, in which functions of the extension function module include a QOS level 0 function, a QOS level 1 function, and a QOS level 2 function.

In addition, when the specific event processing environment is associated with NATS event processing, the event delivery system module may be configured to include the common core module, the convenience core module, and the extension function module, in which functions of the extension function module include a data pre-processing transformer function.

In addition, when the specific event processing environment is associated with NATS streaming event processing, the event delivery system module may be configured to include the common core module, the convenience core module, and the extension function module, in which functions of the extension function module include a QOS level 0 function, a QOS level 1 function, a data pre-processing transformer function, and a stream processing operation function.

In addition, when the specific event processing environment is associated with event delivery processing requiring scale processing scalability, the event delivery system module may be configured by combining the common core module, the convenience core module, and the extension function module.

In addition, when the specific event processing environment is associated with Kafka event processing, the event delivery system module may be configured to include the common core module, the convenience core module, and the extension function module, in which functions of the extension function module include a connector function, a QOS level 0 function, a QOS level 1 function, a QOS level 2 function, a data pre-processing transformer function, and a stream processing operation function.

In addition, when the specific event processing environment is an event delivery system simultaneously requiring delivery scalability and scale processing scalability, the event delivery system module may be configured by combining the common core module, the convenience core module, the scale core module, and the extension function module.

In order to achieve the above objects, a scalable event delivery method supporting flexibility according to the present invention includes: determining an event delivery system module according to an event processing environment and a processing method; and delivering an event by using the event delivery system module, in which among a common core module, a convenience core module, a scale core module, and an extension function module, each being a function module considering a property of each of event processing functions, the event delivery system module is configured by combining two or more modules including at least the common core module on the basis of a specific event processing environment.

In order to achieve the above objects, a scalable event delivery system supporting flexibility according to the present invention includes: among a network adaptation module, a protocol adaptation module, a common core module, a convenience core module, a scale core module, and an extension function module, each being a function module considering a property of each of event processing functions, an event delivery system module configured by combining two or more modules including at least the common core module and the protocol adaptation module on the basis of a specific event processing environment; and a processor performing the specific event processing by using the event delivery system module.

### BRIEF DESCRIPTION OF THE DRAWINGS

The above and other objects, features, and other advantages of the present invention will be more clearly understood from the following detailed description when taken in conjunction with the accompanying drawings, in which:

FIGS. 1 and 2 are diagrams simply illustrating examples of an internal configuration of a general computer system or a network node to which the present invention is applicable;

FIGS. 3A to 9 are diagrams illustrating examples of an event delivery system module according to an embodiment of the present invention;

FIG. 10 is a flowchart illustrating an event delivery system method according to an embodiment of the present invention;

FIGS. 11 to 14 are diagrams illustrating examples of a configuration of an event delivery system module in an event delivery system requiring delivery scalability according to an embodiment of the present invention;

FIG. 15 is a diagram illustrating an example of a configuration of an event delivery system module in an event delivery system requiring scale processing scalability according to an embodiment of the present invention;

FIG. 16 is a diagram illustrating an example of a configuration of an event delivery system module in an event delivery system in which delivery scalability and scale processing scalability are simultaneously required according to an embodiment of the present invention; and

FIGS. 17 and 18 are diagrams illustrating examples of a configuration of an event delivery system module in an event delivery system requiring delivery scalability according to another embodiment of the present invention.

### DETAILED DESCRIPTION OF THE INVENTION

Hereinafter, exemplary embodiments of the present invention will be described in detail with reference to the accompanying drawings so that those skilled in the art may easily implement the present invention. The present invention is implemented in various ways and thus is not limited to embodiment described here.

In following description of embodiments of the present invention, when it is determined that a detailed description of a known structure or function may obscure the gist of the present invention, a detailed description thereof will be omitted. In the drawings, parts irrelevant to the description of the present invention are omitted, and like reference numerals denote like parts.

In the present invention, the components distinguishable from each other are to clearly describe each feature, and it does not necessarily mean that the components are separated. That is, a plurality of components may be integrated into one hardware or software unit, or one component may be distributed into a plurality of hardware or software units. Therefore, even if not mentioned otherwise, such integrated or distributed embodiments are included in the scope of the present invention.

In the present disclosure, components described in various embodiments of the present disclosure are not necessarily required components, and some of them may be optional components. Therefore, an embodiment configured by a subset of the components described in an embodiment is also included in the scope of the present invention. In addition, embodiments including other components in addition to the components described in the various embodiments are included in the scope of the present invention.

Hereinafter, with reference to the accompanying drawings will be described embodiments of the present invention.

FIG. 1 is a diagram illustrating an example of an internal configuration of a general computer system or a network node to which an event delivery system of the present invention is applicable. Referring to FIG. 1, the computer system or the network node to which the event delivery system is applicable according to the present invention includes an event delivery system module 120 and a processor 110 which is a central processing unit.

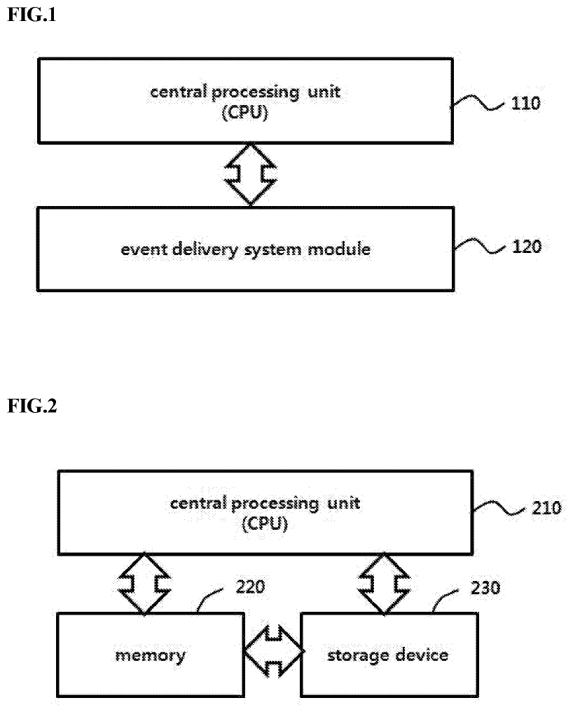

In addition, referring to FIG. 2, a computer system including, for example, a central processing unit (CPU) 210, a memory (DRAM, SRAM, etc.) 220, and a storage device 230, which is an example of a computer system to which a scalable event delivery system supporting flexibility is applied according to the present invention, may be operated in an environment in which the above-described event delivery system module 120 program stored in the storage device 230 is mounted in the memory 220 and then executed by the central processing unit 210, after the power is supplied to the computer system so that the booting is normally completed.

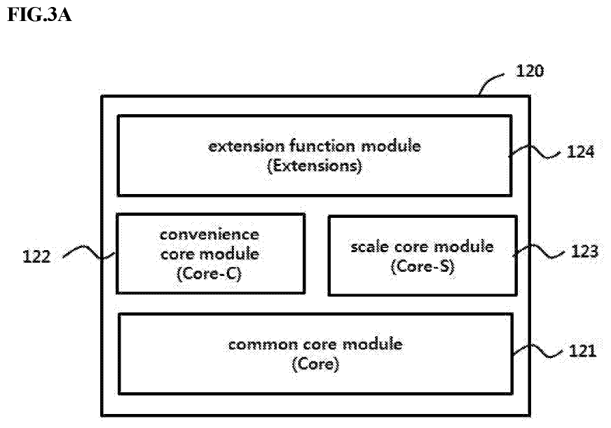

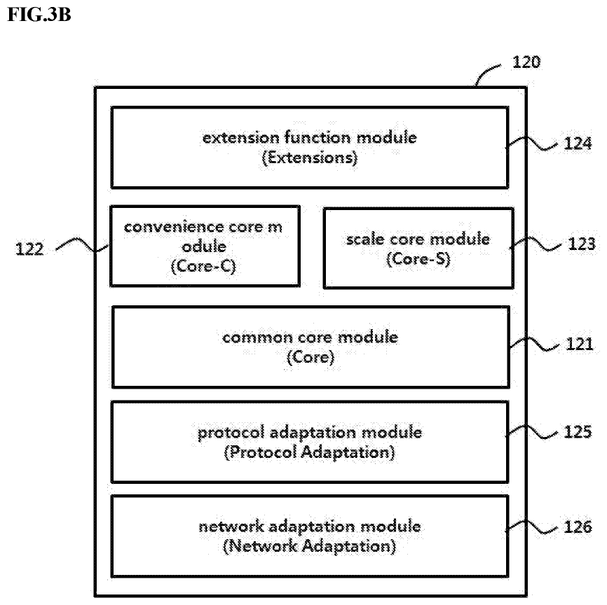

In this regard, FIGS. 3A and 3B are diagrams exemplarily illustrating individual modules that constitute the event delivery system module 120.

First, referring to FIG. 3A, the event delivery system module 120 is divided into, for example, a common core module (Core) 121, a convenience core module 122, and the scale core module 123, and an extension function module 124, as function-specific modules considering attributes of each event processing functions and then configured by combining the modules on the basis of the specific event processing environment. In this regard, the combining of the modules may be configured by combining two or more modules, at least including the common core module. In addition, the processor 110 performs specific event processing by using the event delivery system module 120. In this regard, operation control is performed between the processor 110 and the event delivery system module 120 by utilizing a predefined application program interface (API). Although the modules, for convenience of description, are referred to as the common core module 121, the convenience core module 122, the scale core module 123 and the extension function module 124 according to the present invention, it is obvious that they are limited only to one embodiment and can be named different terms indicating the same purpose and function.

Accordingly, according to the embodiment of FIG. 3A of the present invention, for example, when constructing and providing an event delivery system for optimally delivering and processing a new type of event data in a hyper-connected network, the common core module 121, the convenience core module 122, the scale core module 123, and the extension function module 124 constituting the event delivery system module 120 are flexibly combined, so that only functions required for processing the new type of event data are used, whereby it is possible to implement a scalable event delivery system supporting flexibility.

FIG. 3B is a case in which a network adaptation module 126 and a protocol adaptation module 125 are further included in the event delivery system module 120 of FIG. 3A. That is, both cases in which the event delivery system module 120 is configured according to FIG. 3A and the event delivery system module 120 is configured according to FIG. 3B are possible.

Accordingly, according to the embodiment of FIG. 3B of the present invention, for example, when constructing and providing an event delivery system for optimally delivering and processing a new type of event data in a hyper-connected network, the network adaptation module 126, the protocol adaptation module 125, the common core module (Core) 121, the convenience core module 122, the scale core module 123, and the extension function module 124 constituting the event delivery system module 120 are flexibly combined, so that only functions required for processing the new type of event data are used, whereby it is possible to implement a scalable event delivery system supporting flexibility.

In this regard, the event delivery system module 120 according to the present invention may be implemented with a software program, but the present invention is not necessarily limited thereto. Hereinafter, the event delivery system module 120 implemented with the program will be referred to as an event delivery system module program or an event delivery system program.

In addition, the scalable event delivery system supporting flexibility according to the present invention may also operate as an application program that is independently executed on an operating system (OS) of a bare metal computer.

In addition, the scalable event delivery system supporting flexibility according to the present invention may also operate as an application program that is independently executed on an operating system (OS) of a virtual machine of a virtualized computer.

In addition, the scalable event delivery system supporting flexibility according to the present invention may also operate as an application program that is independently executed in a container or a docker of a virtualized computer.

In addition, the scalable event delivery system supporting flexibility according to the present invention may also operate as an application program that is independently executed in a virtual machine, a container, or a docker provided through cloud service.

In addition, the scalable event delivery system supporting flexibility according to the present invention may operate as an application program that is independently executed on an operating system (OS) of a network device.

Hereinafter, a detailed configuration of an event delivery system module (120 in FIGS. 3A and 3B) according to the present invention will be described with reference to FIG. 3B. However, this is merely an example, and a common core module 121, a convenience core module 122, a scale core module 123, and an extension function module (Ext) 124 which will be described later will be applied to an event delivery system module 120 of FIG. 3A.

FIGS. 3A to 9 are drawings illustrating examples of the event delivery system module 120 according to an embodiment of the present invention.

FIGS. 3A and 3B illustrate examples of the event delivery system module 120 applied to the scalable event delivery system supporting flexibility according to an embodiment of the present invention. Referring to FIG. 3B, the event delivery system module 120 includes a network adaptation module 126, a network adaptation module 125, a protocol adaptation 125, a common core module (Core) 121, a core-convenient module (Core-Convenient or Core-C) 122, a scale core module (Core-Scale or Core-S) 123, and an extension function module (Ext) 124.

Specifically, referring to FIG. 4, the common core module 121 constituting the event delivery system module 120 includes common functions commonly required for a specific event processing environment among event processing functions. For example, functions constituting the common core module 121 may include a subscription management function, a topic management function, a forwarding function, a routing function, and a best-effort delivery function, a consumer health management function, and a policy management function.

In FIG. 4, all common functions of the common core module 121 are illustrated for convenience of description, but at least one of the aforementioned common functions may be included when actually constituting the common core module 121. However, detailed operation of each common function is well known to those skilled in the art, and thus a detailed description thereof will be omitted.

In addition, referring to FIG. 5, the convenience core module 122 of the event delivery system module 120 includes auxiliary functions for increasing convenience associated with a specific event processing environment among event processing functions. For example, the auxiliary functions of the convenience core module 122 may include a queue management function, a core-C consumer health management function, and an authentication function. In FIG. 5, all the auxiliary functions of the convenience core module 122 are illustrated for convenience of description, but at least one of the auxiliary functions described above may be included when actually constituting the convenience core module 122. However, since the specific operation of each auxiliary function is well known to those skilled in the art, the following detailed description will be omitted.

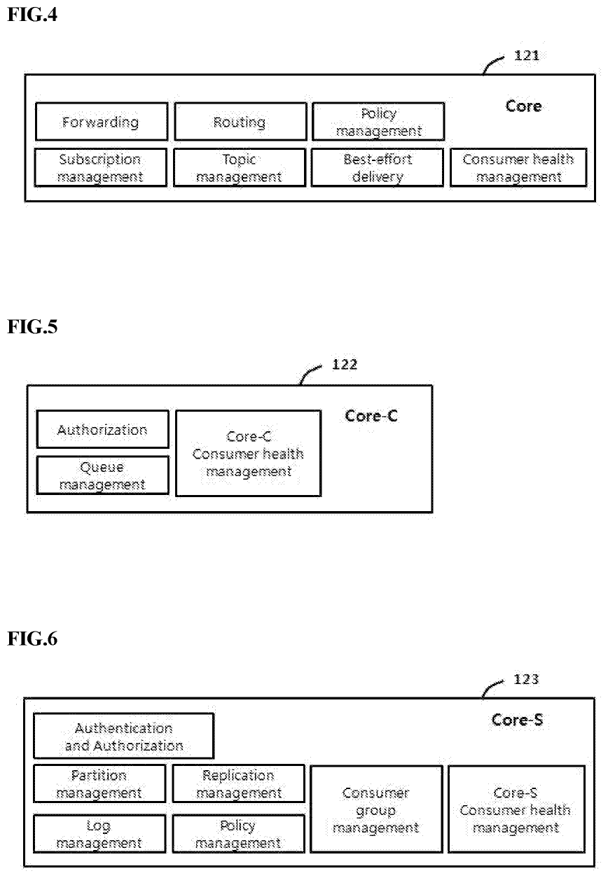

In addition, referring to FIG. 6, the scale core module 123 constituting the event delivery system module 120 includes additional functions related to a specific event processing environment among event processing functions. For example, the additional functions constituting the scale core module 123 may include a log and record management function, a scale core policy management function, a scale core consumer health management function, a consumer group management function, a partition management function, a replication management function, an authentication and authorization function, and the like. In FIG. 6, all the additional functions of the scale core module 123 are illustrated for convenience of description, but at least one of the aforementioned additional functions may be included when actually constituting the scale core module 123. However, the detailed operation of each additional function is well known to those skilled in the art, and thus the detailed description thereof will be omitted.

In addition, referring to FIG. 7, the extension function module 124 constituting the event delivery system module 120 includes extension functions related to a specific event processing environment, among event processing functions. For example, the extension functions of the extension function module (Ext) 124 may include a connector function, a QOS level 0 function, a QOS level 1 function, a QOS level 2 function, an order control function, and a data pre-processing transformer function, and a stream processing operation function. In FIG. 7, all the extension functions of the extension function module (Ext) 124 are illustrated for convenience of description, but at least one of the aforementioned extension functions may be included when actually configuring the extension function module (Ext) 124. However, detailed operation of each extension function is well known to those skilled in the art, and thus a detailed description thereof will be omitted.

In addition, referring to FIG. 8, the protocol adaptation module 125 constituting the event delivery system module 120 includes protocol processing functions related to a specific event processing environment among event processing functions. For example, the protocol adaptation modules may include protocol processing functions such as message queuing telemetry transport (MQTT), advanced message queuing protocol (AMQP), natural autonomic transport system (NATS), and Kafka. However, the protocol adaptation module 125 may include additional protocol adaptation functions as needed in addition to the module. In FIG. 8, all protocol functions constituting the protocol adaptation module 125 are illustrated for convenience of description, but at least one of the aforementioned protocol functions may be included when actually constituting the protocol adaptation module 125. However, since the specific operation of each protocol function is well known to those skilled in the art, the following detailed description will be omitted.

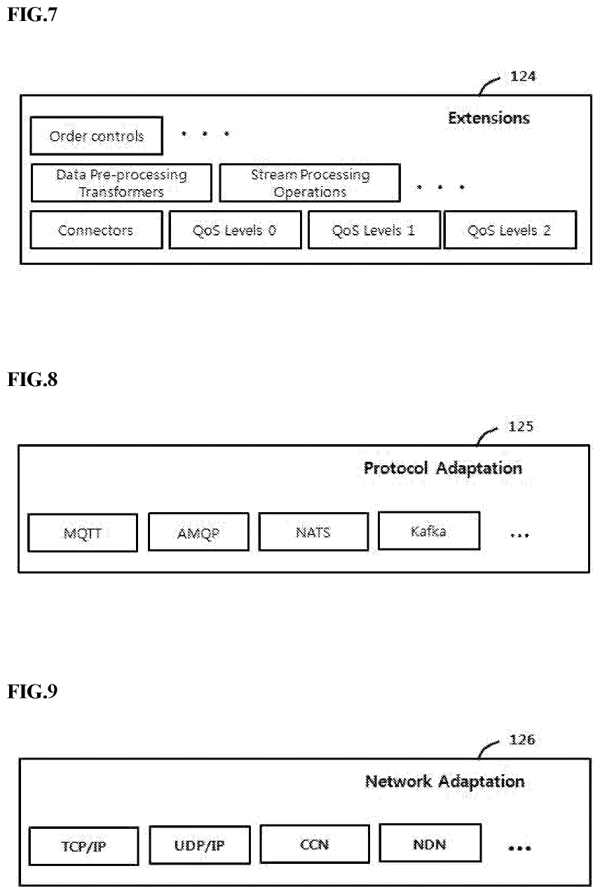

In addition, referring to FIG. 9, the network adaptation module 126 constituting the event delivery system module 120 includes network processing functions related to a specific event processing environment, among event processing functions. For example, the network adaptation modules may include network adaptation functions such as TCP/IP, UDP/IP, content centric networking (CCN), and named data networking (NDN). However, the network adaptation module 126 may include additional network adaptation functions as needed in addition to the module. In FIG. 9, all protocol functions of the network adaptation module 126 are illustrated for convenience of description, but at least one of the aforementioned protocol functions may be included when actually configuring the network adaptation module 126. However, since the specific operation of each protocol function is well known to those skilled in the art, the following detailed description will be omitted.

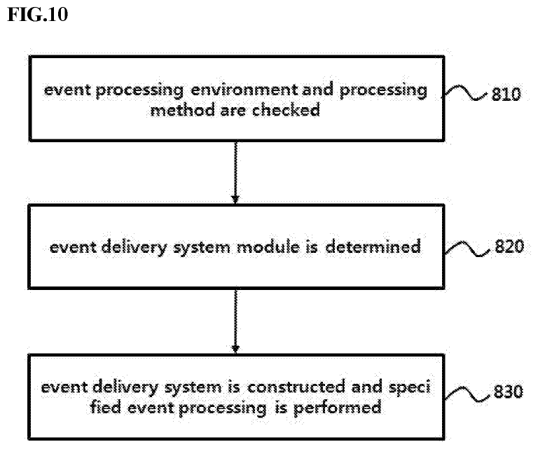

FIG. 10 is a flowchart illustrating an event delivery method according to an embodiment of the present invention. First, an event processing environment and a processing method are checked (810). Herein, the event processing environment and the processing method are possible in various forms, and the present invention will be described below in association with protocol adaptive event processing methods such as MQTT, AMQP, NATS, Kafka, and the like. In addition, according to the event processing environment and the processing method, the event delivery system module as described above is determined (820). Thereafter, by using the determined event delivery system module, the event delivery system is constructed and the specified event processing is performed (830).

In addition, the scalable event delivery system according to the present invention may be configured by combining the network adaptation module 126, the protocol adaptation module 125, the common core module (Core) 121, the convenience core module (Core-C) 122, the scale core module (Core-S) 123, and the extension function module (Ext) 124 in a flexible manner according to a processing method of new types of events.

In addition, the common core module (Core) 121, the convenience core module (Core-C) 122, and the scale core module (Core-S) 123 of the scalable event delivery system according to the present invention may provide their own scalability through optimization of each functional module.

In addition, the convenience core module (Core-C) 122 and the scale core module (Core-S) 123 of the scalable event delivery system according to the present invention are each coupled to the common core module (Core) 121 to process independent functions, and each scalable event delivery system coupled with the common core module (Core) 121 may provide its own scalability.

In addition, each of function modules in the extension function module (Ext) 124 of the scalable event delivery system according to the present invention is coupled to each of the common core module (Core), the convenience core module (Core-C), and the scale core module (Core-S) to process independent functions.

In addition, even when the common core module (Core) 121, the convenience core module (Core-C) 122, and the scale core module (Core-S) 123 of the scalable event delivery system according to the present invention are each combined with any functional module in the extension function module (Ext) 124, each core module may still maintain its own scalability.

In addition, although the common core module (Core) 121, the convenience core module (Core-C) 122, and the scale core module (Core-S) 123 of the scalable event delivery system according to the present invention are each combined with any function module in the extension function module (Ext), the extension function module may still provide its own independent function.

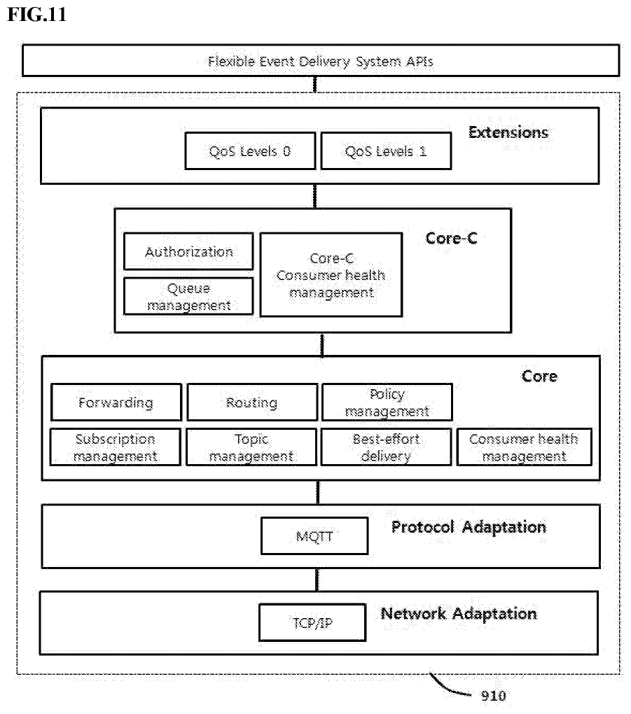

Hereinafter, how the scalable event delivery system according to the present invention is flexibly constituted according to the event processing function required for processing each new type of event will be described with reference to FIGS. 11 to 18.

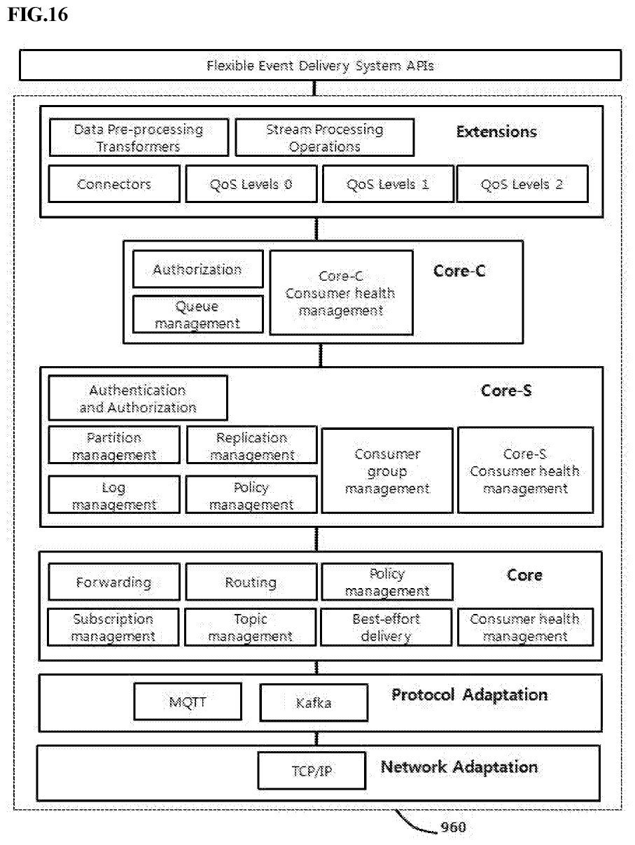

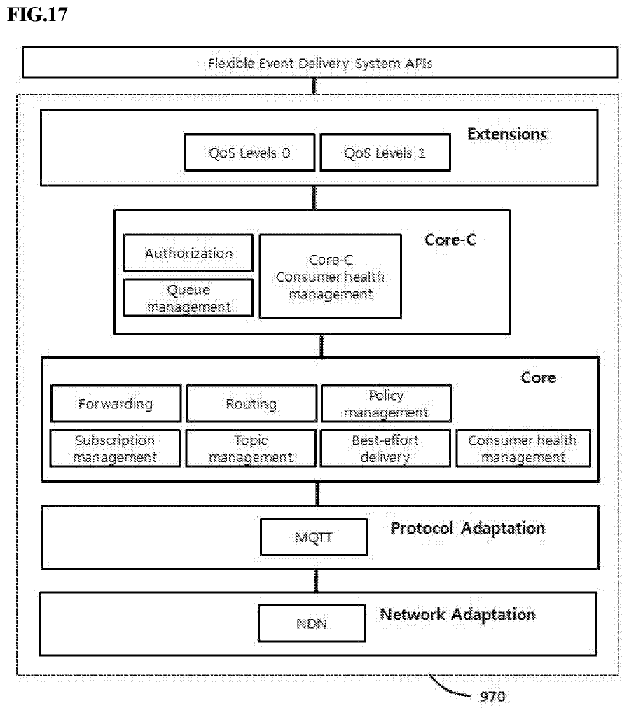

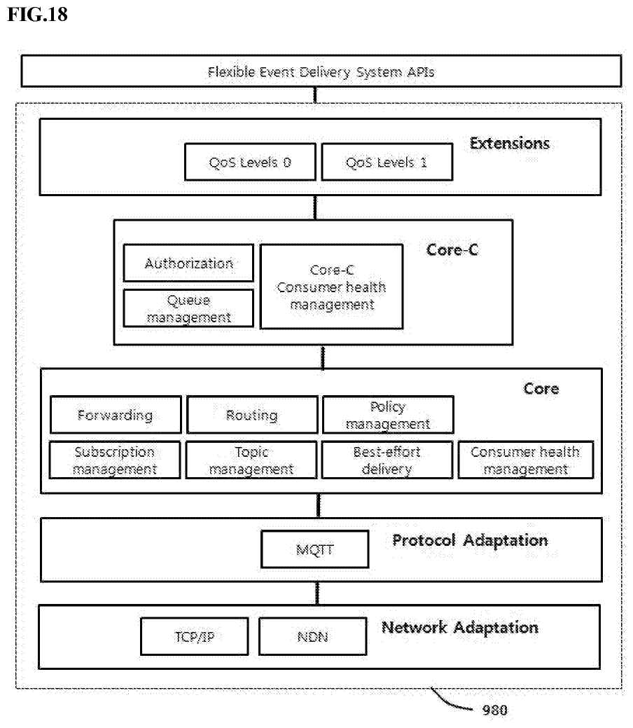

In this regard, FIGS. 11 to 14 are diagrams illustrating examples of a configuration of an event delivery system module in an event delivery system requiring delivery scalability according to an embodiment of the present invention, and FIG. 15 is a diagram illustrating an example of a configuration of an event delivery system module in an event delivery system requiring scale processing scalability according to an embodiment of the present invention. FIG. 16 is a diagram illustrating an example of a configuration of an event delivery system module in an event delivery system in which delivery scalability and scale processing scalability are simultaneously required according to an embodiment of the present invention. In addition, FIGS. 17 and 18 each illustrates an example of a configuration of an event delivery system module in an event delivery system requiring delivery scalability according to another embodiment of the present invention.

Referring to FIGS. 11 to 14, the scalable event delivery system in which delivery scalability is fundamentally required for processing large-capacity events according to the present invention is configured so that the common core module (Core) 121 and the convenience core module (Core-C) 122 are included as a basic configuration, and additional extension function modules (Ext) 124 are flexibly provided for necessary event processing functions. Specifically, it will be described compared to the event processing environment and the processing method as follows.

FIG. 11 illustrates a scalable event delivery system module 910 according to an embodiment of the present invention in which delivery scalability is fundamentally required for processing large-capacity events and a new event in the form of an MQTT requiring QOS0 and QOS1 is processed, in the case of the event delivery system that needs to process, for example, a real-time Internet of Things (IoT) service.

That is, referring to FIG. 11, the common core module (Core) and the convenience core module (Core-C) are included as the basic configuration, and ‘QoS Level 0’ and ‘QoS Level 1’ function modules as the extension function module (Ext), a MQTT module as the protocol adaptation module, and a TCP/IP module as the network adaptation module are flexibly provided, thereby constituting the scalable event delivery system. In this regard, the application program interface (API) of the scalable event delivery system according to the present invention may be used without changing the usage of the existing system.

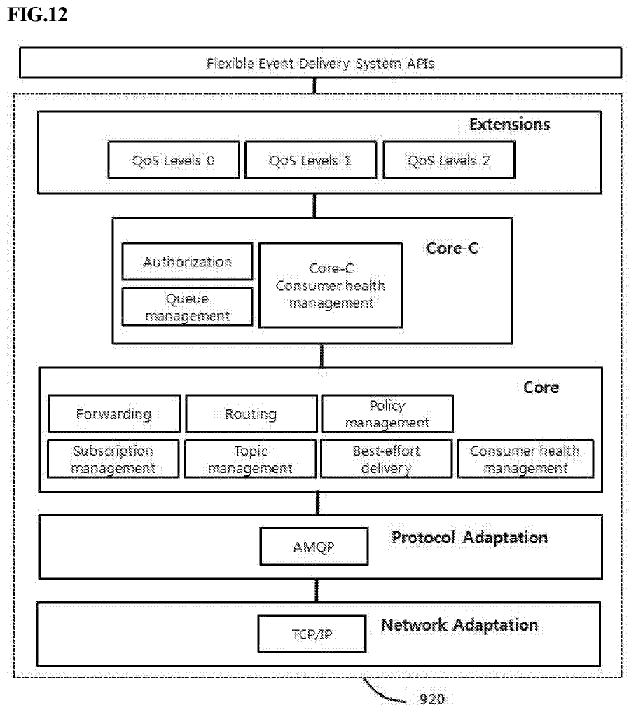

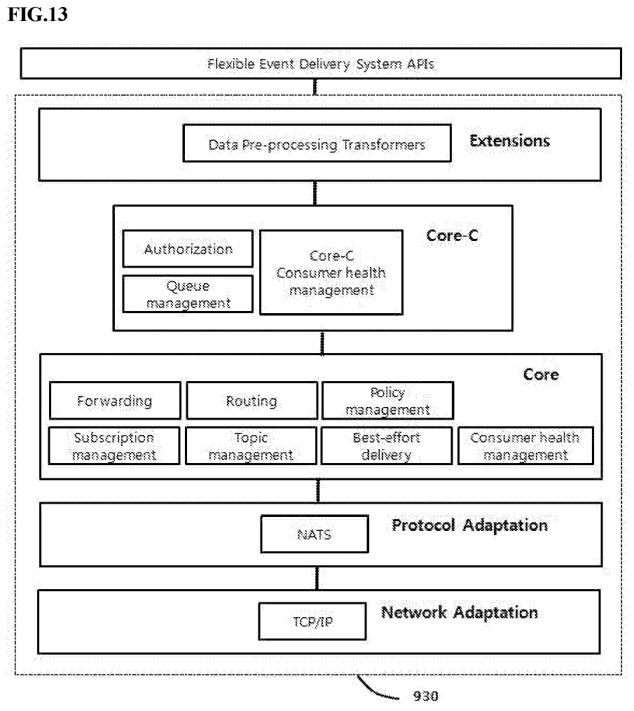

In addition, FIG. 12 shows a scalable event delivery system module 920 according to an embodiment of the present invention in which delivery scalability is fundamentally required for processing large-capacity events and a new event in the form of an AMQP requiring QOS0/QOS1/QOS2 is processed, in the case of an event delivery system that needs to process, for example, a large-capacity business message processing service.

That is, referring to FIG. 12, the common core module (Core) and the convenience core module (Core-C) are included as the basic configuration, and ‘QoS Level 0’, ‘QoS Level 1’, and ‘QoS Level 2’ function modules as the extension function module (Ext), a AMQP module as the protocol adaptation module, and a TCP/IP module as the network adaptation module are flexibly provided, thereby constituting the scalable event delivery system. In this regard, the application program interface (API) of the scalable event delivery system according to the present invention may be used without changing the usage of the existing system.

In addition, FIG. 13 shows a scalable event delivery system module 930 according to an embodiment of the present invention in which delivery scalability is fundamentally required for processing large-capacity events and a new event in the form of a cloud native NATS requiring data pre-processing conversion is processed, in the case of an event delivery system that needs to process, for example, a large-capacity event in a cloud environment.

That is, referring to FIG. 13, the common core module (Core) and the convenience core module (Core-C) are included as the basic configuration, and a data pre-processing transformer module as the extension function module (Ext), a NATS module as the protocol adaptation module, and a TCP/IP module as the network adaptation module are flexibly provided, thereby constituting the scalable event delivery system. In this regard, the application program interface (API) of the scalable event delivery system according to the present invention may be used without changing the usage of the existing system.

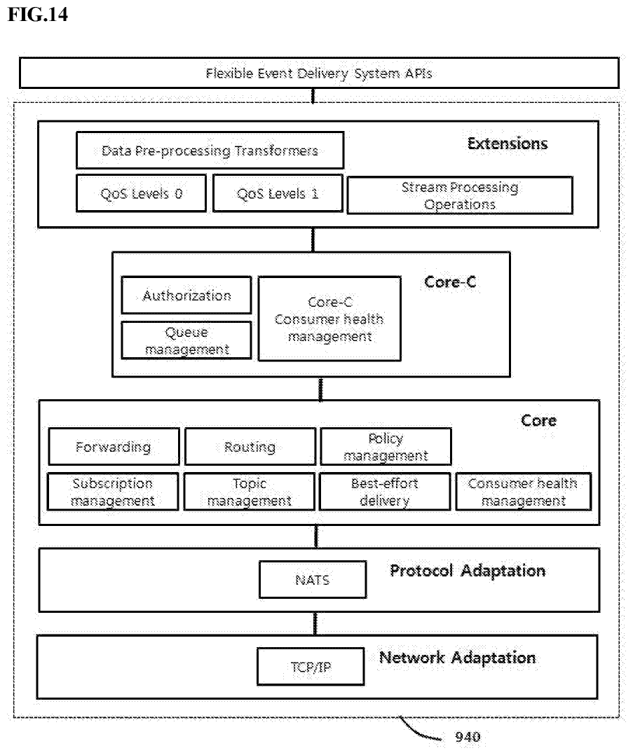

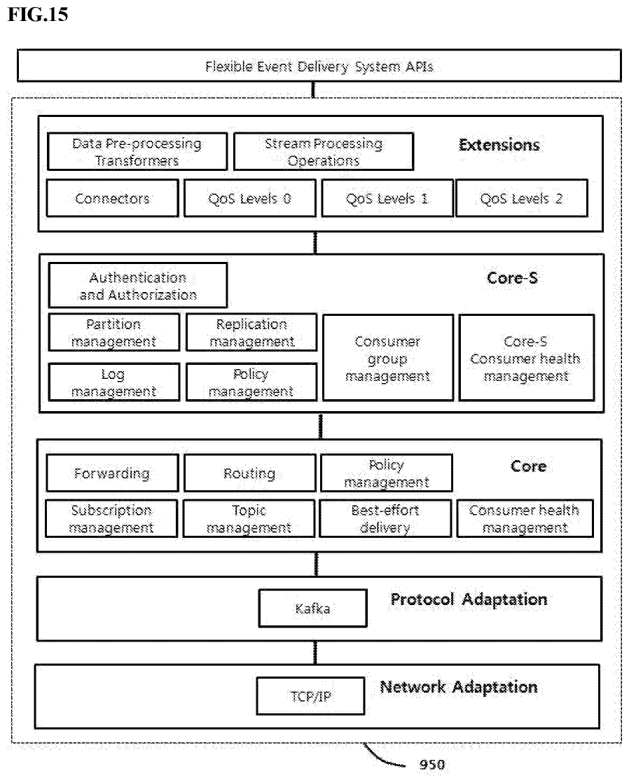

In addition, FIG. 14 illustrates a scalable event delivery system module 940 according to an embodiment of the present invention in which delivery scalability is fundamentally required for processing a large-capacity event and new event in the form of cloud native NATS streaming requiring data pre-processing transform and QOS0/QOS1 and stream processing operations are processed, in the case of an event delivery system that needs to simultaneously process a large-capacity event processing service and a data streaming processing service in a cloud environment.

That is, referring to FIG. 14, the common core module (Core) and the convenience core module (Core-C) are included as the basic configuration, and data pre-processing transformer, QOS level 0, QOS level 1, and stream processing operation function modules, a NATS module, and a TCP/IP module, which are respectively selected as the extension function module (Ext), the extension function module (Ext), and the network adaptation module, are flexibly provided, thereby constituting the scalable event delivery system.

In this regard, the application program interface (API) of the scalable event delivery system according to the present invention may be used without changing the usage of the existing system.

FIG. 15 is a diagram illustrating an example of a configuration of an event delivery system module in an event delivery system requiring scale processing scalability as another embodiment of the present invention. That is, in the present invention, the scalable event delivery system which fundamentally requires scale processing scalability for processing a large-capacity event is configured so that a common core module (Core) and a scale core module (Core-S) are included as basic configurations, and an extension function module (Ext), a protocol adaptation module, and a network adaptation module are flexibly provided.

For example, FIG. 15 illustrates a scalable event delivery system module 950 for processing a new event of a Kafka type in which scale processing scalability is fundamentally required for the sake of large-capacity event processing, in the case of an event delivery system that needs to process a large-capacity event log and a message delivery service.

That is, referring to FIG. 15, the scalable event delivery system is configured so that the common core module (Core) and the scale core module (Core-S) are included as the basic configuration, and data pre-processing transformer, QOS level 0, QOS level 1, QOS level 2, connector, and stream processing operation function modules, a Kafka module, and a TCP/IP module, which are respectively selected as the extension function module (Ext), the protocol adaptation module, and the network adaptation module, are flexibly provided. In this regard, the application program interface (API) of the scalable event delivery system according to the present invention may be used without changing the usage of the existing system.

FIG. 16 is a diagram illustrating an example of a configuration of an event delivery system module in an event delivery system simultaneously requiring delivery scalability and scale processing scalability as another embodiment of the present invention. That is, in the present invention, the scalable event delivery system which simultaneously requires delivery scalability and scale processing scalability for processing a large-capacity event is configured so that the common core module (Core), the convenience core module (Core-C), and the scale core module (Core-S) are included as basic configurations, and the extension function module (Ext), the protocol adaptation module, and the network adaptation module are flexibly provided.

For example, FIG. 16 is a diagram illustrating a scalable event delivery system module 960 according to an embodiment of the present invention, which is to process a new event in the form of a “MQTT+Kafka” combination in which delivery scalability and scale processing scalability are simultaneously required for the sake of large-capacity event processing, in the case of an event delivery system that needs to simultaneously process a real-time Internet of Things (IoT) service, a large-capacity event log, and a message delivery service.

That is, referring to FIG. 16, the scalable event delivery system is configured so that the common core module (Core), the convenient core module (Core-C), and the scale core module (Core-S) are included as the basic configuration, and data pre-processing transformer, QOS level 0, QOS level 1, QOS level 2, connector, and stream processing operation function modules, which are selected as the extension function module (Ext), are flexibly provided. In addition, the scalable event delivery system is configured so that a MQTT module and a Kafka module, and a TCP/IP module, which are respectively selected as the protocol adaptation module and the network adaptation module, are flexibly provided. In this regard, the application program interface (API) of the scalable event delivery system according to the present invention may be used without changing the usage of the existing system.

FIG. 17 is a diagram illustrating a scalable event delivery system module 970 according to another embodiment of the present invention, in which delivery scalability is fundamentally required for large-capacity event processing and the event is delivered through an NDN network in the form of an MQTT protocol requiring QOS0 and QOS1 is shown.

That is, referring to FIG. 17, the scalable event delivery system is configured so that the common core module (Core) and the convenient core module (Core-C) are included as the basic configuration, and “QOS level 0” and “QOS level 1” function modules, a MQTT module, and a MDN module, which are respectively selected as the extension function module (Ext), the protocol adaptation module, and the network adaptation module, are flexibly provided. In this regard, the application program interface (API) of the scalable event delivery system according to the present invention may be used without changing the usage of the existing system.

FIG. 18 is a diagram illustrating a scalable event delivery system module 980 according to another embodiment another embodiment of the present invention, in which delivery scalability is fundamentally required for large-capacity event processing and the event is delivered through an NDN network in the form of an MQTT protocol requiring QOS0 and QOS1 is shown.

That is, referring to FIG. 18, the scalable event delivery system is configured so that the common core module (Core) and the convenient core module (Core-C) are included as the basic configuration, and “QOS level 0” and “QOS level 1” function modules, a MQTT module, and a MDN module and a TCP/IP module, which are respectively selected as the extension function module (Ext), the protocol adaptation module, and the network adaptation module, are flexibly provided. In this regard, the application program interface (API) of the scalable event delivery system according to the present invention may be used without changing the usage of the existing system.

The various embodiments of the present disclosure are not an exhaustive list of all possible combinations and are intended to describe representative aspects of the present disclosure, and the matters described in the various embodiments may be applied independently or in combination of two or more.

In addition, various embodiments of the present disclosure may be implemented by hardware, firmware, software, or a combination thereof. Hardware implementations can be performed by one or more application specific integrated circuits (ASICs), digital signal processors (DSPs), digital signal processing devices (DSPDs), programmable logic devices (PLDs), field programmable gate arrays (FPGAs), a general processor, a controller, a microcontroller, and the like.

It is intended that the scope of the disclosure include software or machine-executable instructions (e.g., an operating system, an application, firmware, a program, etc.) by which operations according to methods of various embodiments are executed on an apparatus or a computer, and non-transitory computer-readable medium executable on an apparatus or a computer in which such software or instruction is stored.

The present invention described above is capable of various substitutions, modifications, and changes within the scope of the present invention to those skilled in the art without departing from the spirit of the present invention, and thus the scope of the present invention described above is not limited by the embodiment and the accompanying drawings.

What is claimed is:

1. A scalable event delivery system supporting flexibility, the scalable event delivery system comprising:
an event delivery system module configured by combining two or more modules including at least a common core module on the basis of a specific event processing environment, among the common core module, a convenience core module, a scale core module, and an extension function module, each being a function module considering a property of each of event processing functions; and
a processor performing the specific event processing by using the event delivery system module.

2. The scalable event delivery system of claim 1, wherein the common core module includes common functions necessary for the specific event processing environment among the event processing functions.

3. The scalable event delivery system of claim 2, wherein the common core module includes at least one of a subscription management function, a topic management function, a forwarding function, a routing function, a best-effort delivery function, and a subscriber health management function, and a police management function.

4. The scalable event delivery system of claim 1, wherein the convenience core module includes, among the event processing functions, auxiliary functions for increasing convenience related to the specific event processing environment.

5. The scalable event delivery system of claim 4, wherein the convenience core module includes at least one of a queue management function, a core consumer health management function, and an authorization function.

6. The scalable event delivery system of claim 1, wherein the scale core module includes additional functions related to the specific event processing environment, among the event processing functions.

7. The scalable event delivery system of claim 6, wherein the scale core module includes at least one of a log and record management function, a scale core policy management function, a scale core consumer health management function, and a consumer group management function, a partition management function, a replication management function, and an authentication and authorization function.

8. The scalable event delivery system of claim 1, wherein the extension function module includes extension functions related to the specific event processing environment, among the event processing functions.

9. The scalable event delivery system of claim 8, wherein the extension function module includes at least one of a connector function, a QOS level 0 function, a QOS level 1 function, a QOS level 2 function, and an order control function, a data pre-processing transformer function, and a stream processing operation function.

10. The scalable event delivery system of claim 1, wherein when the specific event processing environment is an event delivery system requiring delivery scalability, the event delivery system module is configured by combining the common core module, the convenience core module, and the extension function modules.

11. The scalable event delivery system of claim 10, wherein when the specific event processing environment is associated with MQTT event processing, the event delivery system module is configured to include the common core module, the convenience core module, and the extension function module, in which functions of the extension function module include a QOS level 0 function and a QoS Level 1 function.

12. The scalable event delivery system of claim 10, wherein when the specific event processing environment is associated with AMQP event processing, the event delivery system module is configured to include the common core module, the convenience core module, and the extension function module, in which functions of the extension function module include a QOS level 0 function, a QOS level 1 function, and a QOS level 2 function.

13. The scalable event delivery system of claim 10, wherein when the specific event processing environment is associated with NATS event processing, the event delivery system module is configured to include the common core module, the convenience core module, and the extension function module, in which functions of the extension function module include a data pre-processing transformer function.

14. The scalable event delivery system of claim 10, wherein when the specific event processing environment is associated with NATS streaming event processing, the event delivery system module is configured to include the common core module, the convenience core module, and the extension function module, in which functions of the extension function module include a QOS level 0 function, a QOS level 1 function, a data pre-processing transformer function, and a stream processing operation function.

15. The scalable event delivery system of claim 1, wherein when the specific event processing environment is associated with event delivery processing requiring scale processing scalability, the event delivery system module is configured by combining the common core module, the convenience core module, and the extension function module.

16. The scalable event delivery system of claim 15, wherein when the specific event processing environment is associated with Kafka event processing, the event delivery system module is configured to include the common core module, the convenience core module, and the extension function module, in which functions of the extension function module include a connector function, a QOS level 0 function, a QOS level 1 function, a QOS level 2 function, a data pre-processing transformer function, and a stream processing operation function.

17. The scalable event delivery system of claim 1, wherein when the specific event processing environment is an event delivery system simultaneously requiring delivery scalability and scale processing scalability, the event delivery system module is configured by combining the common core module, the convenience core module, the scale core module, and the extension function module.

18. A scalable event delivery method supporting flexibility, the scalable event delivery method comprising:
determining an event delivery system module according to an event processing environment and a processing method; and
delivering an event by using the event delivery system module,
in which among a common core module, a convenience core module, a scale core module, and an extension function module, each being a function module considering a property of each of event processing functions, the event delivery system module is configured by combining two or more modules including at least the common core module on the basis of a specific event processing environment.

19. A scalable event delivery system supporting flexibility, the scalable event delivery system comprising:
an event delivery system module configured by combining two or more modules including at least a common core module and a protocol adaptation module on the basis of a specific event processing environment, among a network adaptation module, the protocol adaptation module, the common core module, a convenience core module, a scale core module, and an extension function module, each being a function module considering a property of each of event processing functions; and
a processor performing the specific event processing by using the event delivery system module.
